(19) United States
(12) Patent Application Publication
(10) Pub. No.: US 2012/0229123 A1
(43) Pub. Date: Sep. 13, 2012

(54) MAGNETIC RING ENCODING DEVICE FOR COMPOSITE SIGNALS

(76) Inventors: Chi-Yuan CHENG, Taichung City (TW); Chih-Mao SHIAO, Taichung City (TW); Ming Fu TSAI, Taichung City (TW)

(21) Appl. No.: 13/044,472

(22) Filed: Mar. 9, 2011

(51) Int. Cl. G01B 7/30

(52) U.S. Cl. 324/207.2

(57) ABSTRACT

A magnetic ring encoding device for composite signals, which is disposed at an end of a rotary shaft of a rotary motor. The magnetic ring encoding device includes: a magnetic ring having a ring-shaped body section synchronously rotatable with the rotary shaft of the rotary motor, multiple magnetic poles being arranged on the body section at equal intervals; multiple Hall elements located and arranged around the body section at intervals, the Hall elements serving to sense magnetic field change that takes place when the magnetic poles pass through the Hall elements and output sensed signals according to the magnetic field change; and an adder for performing addition operation for the sensed signals output from the Hall elements.

### BACKGROUND OF THE INVENTION

1. Field of the Invention

The present invention relates generally to a motor, and more particularly to a magnetic ring encoding device for composite signals.

2. Description of the Related Art

The conventional position feedback techniques of a rotary motor can be divided into magnetic field sensing technique or optical sensing technique. No matter whether the magnetic field sensing technique or optical sensing technique is used, the basic structure of the rotary motor includes a rotary element that is synchronously rotatable with the rotary shaft of the rotary motor. The rotational state of the rotary element is sensed by suitable sensing elements to indirectly obtain the rotational position of the motor via the rotary element for generating position feedback signal.

In the field of magnetic field sensing technique, the basic structure substantially includes a magnetic ring and a read head. The magnetic ring is coaxially disposed at one end of the rotary shaft of the rotary motor. Multiple magnetic poles are sequentially annularly arranged on the magnetic ring. The read head is fixedly located and is a sensing element composed of such as magnetic resistance sensors. Accordingly, when the magnetic ring synchronously rotates along with the rotary shaft of the rotary motor, the magnetic poles arranged on the magnetic ring in NSNS sequence will sequentially pass through the position of the read head to create corresponding magnetic field for the read head to generate corresponding position feedback signal. Such technique pertains to well known prior art. However, there are still some shortcomings existing in such technique.

To speak more specifically, the conventional technique that employs one single read head for sensing magnetic field change taking place when the magnetic ring rotates has at least the shortcomings as follows:
1. The cost for the magnetic read head employed in the conventional technique is higher. As a result, the manufacturing cost as a whole can be hardly lowered.
2. Only one single read head is used. Therefore, when assembled and processed, the distance between the read head and the magnetic ring must be specially adjusted to a proper value. Moreover, a high precision of concentricity between the magnetic ring and the rotary shaft of the motor is required. In other words, the precision required in the assembling and processing procedure is higher. As a result, more time and labor are consumed.
3. In the case that a too small or a too large interval exists between the read head and the magnetic ring, the magnetic field intensity sensed by the read head will be directly affected. This s will cause too weak or too strong position feedback signal output. Under such circumstance, it will be hard for the position feedback signal receiving end to analyze the true position.
4. In the case the concentricity between the magnetic ring and the rotary shaft of the motor is poor, this will lead to deterioration of absolute precision of the position feedback signal. Under such circumstance, it is hard to obtain true positional data. As a result, the rotation of the motor can be hardly precisely controlled.

### SUMMARY OF THE INVENTION

It is therefore a primary object of the present invention to provide a magnetic ring encoding device for composite signals, which is manufactured at lower cost and is able to achieve better absolute precision.

To achieve the above and other objects, the magnetic ring encoding device for composite signals of the present invention is disposed at an end of a rotary shaft of a rotary motor. The magnetic ring encoding device includes: a magnetic ring having a ring-shaped body section synchronously rotatable with the rotary shaft of the rotary motor, multiple magnetic poles being arranged on the body section at equal intervals; multiple Hall elements located and arranged around the body section at intervals, the Hall elements serving to sense magnetic field change that takes place when the magnetic poles pass through the Hall elements and output sensed signals according to the magnetic field change; and an adder for performing addition operation for the sensed signals output from the Hall elements.

The present invention can be best understood through the following description and accompanying drawings, wherein:

### BRIEF DESCRIPTION OF THE DRAWINGS

FIG. 1 is a plane view of a preferred embodiment of the present invention;

FIG. 2 is a plane view according to FIG. 1, showing that the signals are captured by the Hall elements;

FIG. 3 is a respective waveform diagram of multiple sine signals captured when the rotary shaft of the rotary motor rotates by one scale;

FIG. 4 is a summed waveform diagram of multiple sine signals captured when the rotary shaft of the rotary motor rotates by one scale; and

FIG. 5 is a plane view of a preferred embodiment of the present invention.

### DETAILED DESCRIPTION OF THE PREFERRED EMBODIMENTS

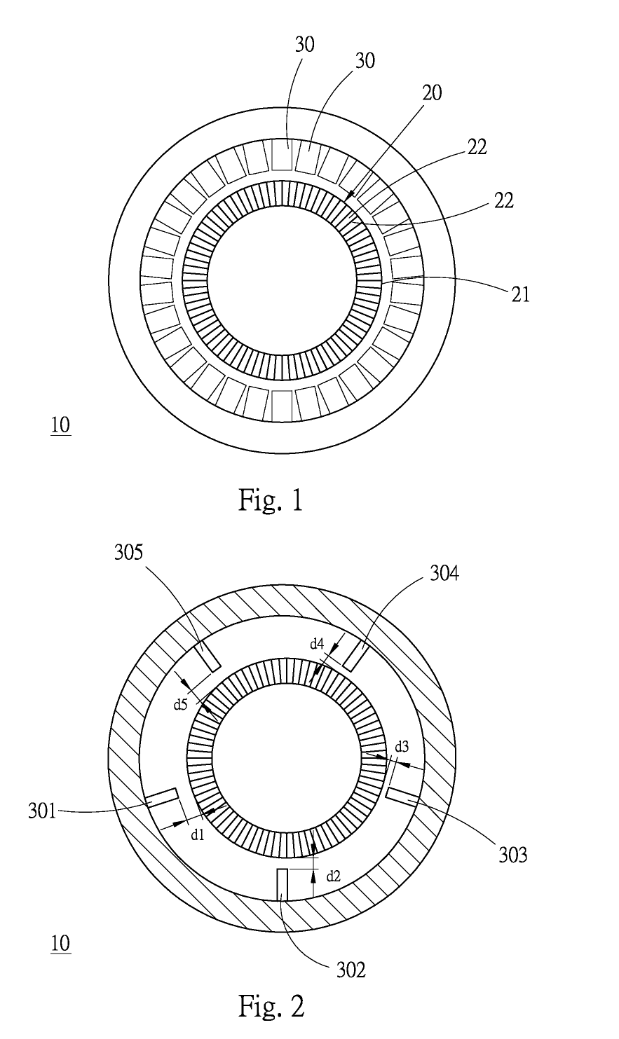

Please refer to FIG. 1. According to a preferred embodiment, the magnetic ring encoding device 10 for composite signals of the present invention includes a magnetic ring 20, multiple Hall elements 30 and an adder (not shown).

The magnetic ring 20 pertains to prior art. The magnetic ring 20 substantially has a ring-shaped body section 21 disposed at an end of the rotary shaft of a rotary motor and synchronously rotatable with the rotary shaft of the rotary motor. Multiple magnetic sectors 22 are arranged on the body section 21 at equal intervals.

The Hall elements 30 are conventional Hall effect semiconductor sensors, which are sequentially located and arranged around the body section 20 in an annular form centered at the axis of the rotary shaft. Accordingly, when the body section 21 rotates along with the rotary shaft of the rotary motor, the magnetic poles 22 on the body section 21 sequentially pass through the Hall elements 30 to correspondingly change magnetic flux density applied to the Hall elements 30 so as to achieve the corresponding sensed sine wave signal.

The adder is a conventional electronic component with an adder circuit for addition operation of the sensed waveform signal.

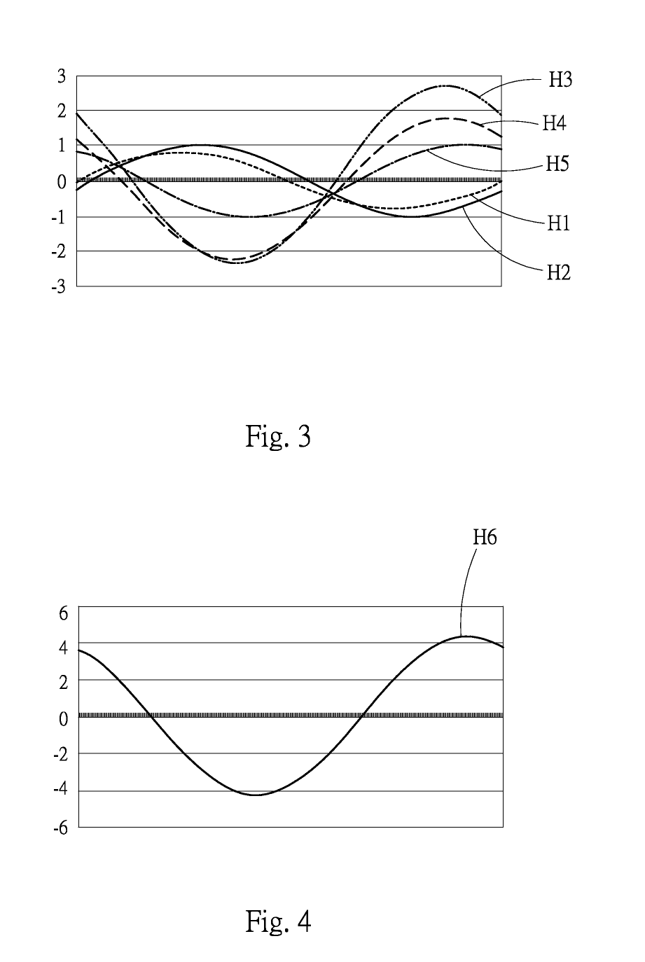

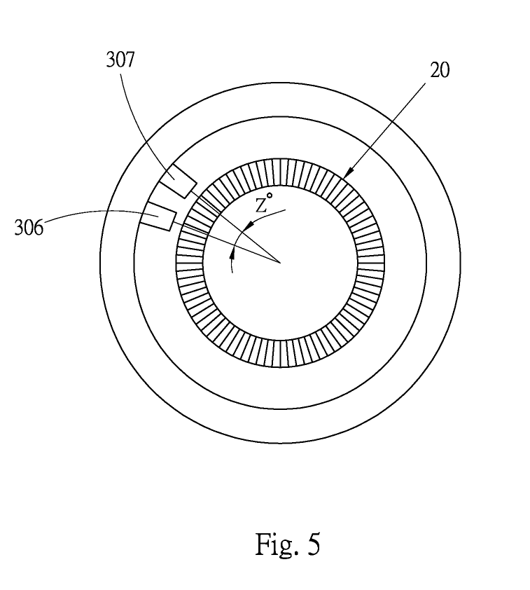

Please now refer to FIGS. 2 and 4. As exemplified with the five Hall elements 301, 302, 303, 304, 305 of FIG. 2, the five Hall elements 301, 302, 303, 304, 305 are arranged in an annular form centered at the axis of the rotary shaft of the rotary motor. In case that the concentricity between the body section 21 and the rotary shaft of the rotary motor is poor, that is, a certain eccentricity exists between the body section 21 and the rotary shaft of the rotary motor, the magnetic poles 22 on the body section 21 are spaced from the corresponding Hall elements 301, 302, 303, 304, 305 in different positions by unequal distances d1, d2, d3, d4, d5 due to the displacement of the body section 21. It is known that the magnetic field intensity is in inverse proportion to the distance. Therefore, the magnetic field intensity applied to the Hall elements 301, 302, 303, 304, 305 by the magnetic sectors 22 varies with the distance. Accordingly, as shown in FIG. 3, the different Hall elements 301, 302, 303, 304, 305 will output different sensed sine wave signals H1, H2, H3, H4, H5 due to different magnetic flux density. At this time, even if the obtained signals are decoded, it is impossible to form correct corresponding data for use. Under such circumstance, it is necessary to perform addition operation for the sensed sine wave signals H1, H2, H3, H4, H5 by means of the adder to sum and form one single waveform signal H6 for successive decoding.

When using the adder to sum the sensed signals output from the Hall elements 301, 302, 303, 304, 305, the phase, amplitude and voltage offset of the signals can be averaged to achieve a waveform diagram with stable amplitude and lower voltage offset so as to obtain better absolute precision. Therefore, even if the concentricity between the body section 21 and the rotary shaft of the rotary motor is poor, high-precision sensed signals can be still obtained. In comparison with the conventional technique, in assembling and manufacturing process of the magnetic ring encoding device 10 for composite signals of the present invention, the requirement for concentricity between the body section 21 and the annular form of the Hall elements 30 is not high. In this case, the working time and cost for the assembling process can be lowered and the manufacturing efficiency can be promoted. Therefore, the shortcomings of the conventional technique are overcome and a better absolute precision is achieved. Moreover, the cost for the Hall elements is lower than the cost for the read head used in the conventional device. Therefore, the material cost of the present invention is also lower than that of the conventional device.

In addition, in the above embodiment, the sine signal is captured as an example. However, it is necessary to further describe the relative positions of the Hall elements 306 for capturing sine signal and the Hall elements 307 for capturing cosine signals when the magnetic ring encoding device 10 captures both sine signals and cosine signals. Substantially, a Hall element 306 for capturing sine signal and a Hall element 307 for capturing cosine signal in adjacency to the Hall element 306 can capture the same sine/cosine signal. In this case, the Hall elements 306, 307 must be arranged at a certain angular interval Z° in accordance with the equation as follows:

Z=90/Y,

wherein:
Y: the number of sine/cosine waves generated by the magnetic ring.

Accordingly, it can be ensured that the difference between the sine signal and the cosine signal is 90 degrees.

However, the size of the magnetic poles 22 is in inverse proportion to the number of the magnetic poles 22. In addition, the Hall elements have their own original size. Therefore, in the case that the Hall elements have such a larger size as to cross different magnetic poles, it will be hard to arrange the Hall elements 306, 307 for capturing the sine/cosine signals of the same sine/cosine wave. Under such circumstance, the Hall elements can capture the signals of different sine/cosine waves. However, in order to obtain a true signal, the adjacent Hall elements for capturing the sine signal and the cosine signal must be arranged at an angular interval Z° in accordance with the equation as follows:

Z=n(360/Y)+90/Y,

wherein:
Y: the total number of sine/cosine waves generated by the magnetic ring, and
n: the number of the sine/cosine waves between the different sine/cosine waves of the captured signal.

The above embodiments are only used to illustrate the present invention, not intended to limit the scope thereof. Many modifications of the above embodiments can be made without departing from the spirit of the present invention.

What is claimed is:

1. A magnetic ring encoding device for composite signals, which is disposed at an end of a rotary shaft of a rotary motor, the magnetic ring encoding device comprising:
a magnetic ring having a ring-shaped body section synchronously rotatable with the rotary shaft of the rotary motor, multiple magnetic poles being arranged on the body section at equal intervals;
multiple Hall elements located and arranged around the body section at intervals, the Hall elements serving to sense magnetic field change that takes place when the magnetic poles pass through the Hall elements and output sensed signals according to the magnetic field change; and
an adder for performing addition operation for the sensed signals output from the Hall elements.

2. The magnetic ring encoding device for composite signals as claimed in claim 1, wherein the magnetic poles are annularly arranged on the body section with the adjacent magnetic poles having different polarities.

3. The magnetic ring encoding device for composite signals as claimed in claim 1, wherein a part of each Hall element serves to capture sine signal, while other parts of the Hall element serve to capture cosine signal.

4. The magnetic ring encoding device for composite signals as claimed in claim 3, wherein in the case that the adjacent Hall elements for capturing sine signal and for capturing cosine signals are used to capture the sine signal and cosine signal of the same sine/cosine wave of multiple sine/cosine waves generated by the magnetic ring, the Hall elements are arranged at an angular interval Z° in accordance with the equation as follows:
Z=90/Y,
wherein:
Y: the total number of sine/cosine waves generated by the magnetic ring.

5. The magnetic ring encoding device for composite signals as claimed in claim 3, wherein in the case that the adjacent Hall elements for capturing sine signal and for capturing cosine signals are used to capture the sine signal and cosine signal of different sine/cosine waves of multiple sine/cosine waves generated by the magnetic ring, the Hall elements are arranged at an angular interval Z° in accordance with the equation as follows:
Z=n(360/Y)+90/Y,
wherein:
Y: the total number of sine/cosine waves generated by the magnetic ring, and
n: the number of the sine/cosine waves between the different sine/cosine waves of the captured signal.
